(19) United States
(12) Patent Application Publication
(10) Pub. No.: US 2014/0376869 A1
(43) Pub. Date: Dec. 25, 2014

(54) OPTICAL FIBER INCLUDING A PLURALITY OF SUB-CORE AREAS

(71) Applicant: Samsung Electronics Co., Ltd., Suwon-si (KR)

(72) Inventors: Yeong-Seop LEE, Gumi-si (KR); Mun-Hyun DO, Daegu-si (KR); Dae-Seung MOON, Gumi-si (KR); Si-Ho SONG, Gumi-si (KR); Dea-Hwan OH, Gumi-si (KR); Tae-Hyung LEE, Gumi-si (KR)

(73) Assignee: Samsung Electronics Co., Ltd., Suwon-si (KR)

(21) Appl. No.: 14/302,943

(22) Filed: Jun. 12, 2014

(30) Foreign Application Priority Data
Jun. 20, 2013 (KR) 10-2013-0070872

(51) Int. Cl. G02B 6/02

(52) U.S. Cl. CPC G02B 6/02038
USPC 385/127

(57) ABSTRACT

An optical fiber is provided. The optical fiber includes a core located at the center of the optical fiber and having a maximum refractive index in the optical fiber, and a cladding located at a circumference of the core and having a refractive index lower than that of the core. The core has a structure in which sub-core areas having the refractive index higher than those of adjacent sub-core areas and sub-core areas having the refractive index lower than those of adjacent sub-core areas are alternately repeated.

### CROSS-REFERENCE TO RELATED APPLICATION(S)

This application claims the benefit under 35 U.S.C. §119(a) of a Korean patent application filed on Jun. 20, 2013 in the Korean Intellectual Property Office and assigned Serial number 10-2013-0070872, the entire disclosure of which is hereby incorporated by reference.

### TECHNICAL FIELD

The present disclosure relates to an optical communication. More particularly, the present disclosure relates to an optical fiber used as a transmission path for an optical signal.

### BACKGROUND

Optical fibers which provide a transmission media of optical communication systems have an advantage of having a very large transmission bandwidth of several tens of THz, and thus are being very widely used.

Due to the characteristics of an optical communication system, the optical communication system shows a high signal extinction ratio and a high input power is input to transmit data to a site located far away, but shows various nonlinear effects since the optical fiber uses silica.

A Brillouin scattering phenomenon which is one of the nonlinear effects generated in optical fiber functions to send input light rearwards. Brillouin scattering generates a stimulating operation in an input power of greater than or equal to a threshold value to send light rearwards more strongly, and the stimulated Brillouin scattering phenomenon is generated at a relatively low input power unlike the other nonlinear effects to significantly influence an entire performance of the optical communication system.

Methods for improving the entire performance of an optical communication system determined by a stimulated Brillouin scattering phenomenon include a method of using a signal having a wide line width, a method of reducing a span length of an optical fiber used in an optical communication system, and a method of changing the refractive index in a lengthwise direction of an optical fiber.

A method of adjusting a refractive index of an optical fiber may be considered to reduce overlapping between an optical mode in which light proceeds in the optical fiber and an acoustic mode created by an interaction of light which scatters and proceeds rearwards.

According to the method, a refractive index profile of an optical fiber may be adjusted by using doping materials such as Al, B, and F as well as GE in a core of the optical fiber and overlapping may be reduced by changing the forms of an optical mode and an acoustic mode. The method requires an additional setup for doping an additional material in an existing optical fiber manufacturing process, which increases manufacturing costs, makes a manufacturing process complex to dope different materials, and increases a time period for manufacturing an optical fiber.

In this method, when several doping materials as well as Ge are used in the core, a light attenuation of the optical fiber may increase, which may lower performance of an optical communication system.

Accordingly, an optical fiber manufacturing process that is simplified and the optical fiber that may be easily mass-produced as compared with a method of changing a refractive index in a lengthwise direction of an optical fiber, for example, by changing a refractive index structure of an optical fiber only in a radial direction of the optical fiber while fixing the refractive index structure in a lengthwise direction of the optical fiber is desired.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure, provides an optical fiber manufacturing process that is simplified and the optical fiber that may be easily mass-produced as compared with a method of changing a refractive index in a lengthwise direction of an optical fiber, for example, by changing a refractive index structure of an optical fiber only in a radial direction of the optical fiber while fixing the refractive index structure in a lengthwise direction of the optical fiber.

Another aspect of the present disclosure is to provide a threshold input power of stimulated Brillouin scattering can be improved by doping only Ge, for example, without using dissimilar or various doping materials as in the related art and changing a refractive index structure only in a radial direction of an optical fiber to improve the threshold input power of the stimulated Brillouin scattering.

Another aspect of the present disclosure is to provide a threshold input power value of stimulated Brillouin scattering can be increased, for example, by changing a refractive index of a core area of an optical fiber in a radial direction of the optical fiber. Thus, the present disclosure can be applied to an optical communication system operated under an input power higher than that of the related art while having an excellent signal/noise ratio.

In accordance with an aspect of the present disclosure an optical fiber is provided. The optical fiber including a core located at the center of the optical fiber and having a maximum refractive index in the optical fiber, and a cladding located at a circumference of the core and having a refractive index lower than that of the core, wherein the core has a structure in which sub-core areas having the refractive index higher than those of adjacent sub-core areas and sub-core areas having the refractive index lower than those of adjacent sub-core areas are alternately repeated.

In accordance with an aspect of the present disclosure an optical fiber is provided. The optical fiber including a core located at the center of the optical fiber and having a maximum refractive index in the optical fiber, and a cladding located at a circumference of the core and having a refractive index lower than that of the core, wherein the core has a first sub-core area located at the center of the core and a second sub-core area located at a circumference of the first sub-core area and having a refractive index which gradually increases as the refractive index goes to an outer periphery thereof.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view for explaining stimulated Brillouin scattering according to an embodiment of the present disclosure;

FIGS. 2A, 2B, and 2C show an optical fiber according to an embodiment of the present disclosure;

FIG. 3 shows a refraction index profile of a core according to an embodiment of the present disclosure;

FIG. 4 shows an acoustic velocity profile of the core according to an embodiment of the present disclosure;

FIG. 5 shows normalized power profiles of an optical signal and scattering light according to an embodiment of the present disclosure;

FIGS. 6A, 6B, and 6C show an optical fiber according to another embodiment of the present disclosure;

FIG. 7 shows a refraction index profile of a core according to an embodiment of the present disclosure;

FIG. 8 shows an acoustic velocity profile of the core according to an embodiment of the present disclosure; and

FIG. 9 shows normalized power profiles of an optical signal and scattering light according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although the terms including an ordinal number such as first, second, and so on, may be used for describing various elements, the elements are not restricted by the terms. The terms are only used to distinguish one element from another element. For example, without departing from the scope of the present disclosure, a first structural element may be named a second structural. Similarly, the second structural element also may be named the first structural element. As used herein, the term “and/or” includes any and all combinations of one or more of the associated listed items.

In the present disclosure, the terms are used to describe a specific embodiment, and are not intended to limit the present disclosure. As used herein, the singular forms are intended to include the plural forms as well, unless the context clearly indicates otherwise. In the description, it should be understood that the terms “include” or “have” indicate existences of a feature, a number, a step, an operation, a structural element, parts, or a combination thereof, and do not previously exclude the existences or probability of addition of one or more another features, numeral, steps, operations, structural elements, parts, or combinations thereof.

Unless defined differently, all terms used herein, which include technical terminologies or scientific terminologies, have the same meaning as a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present specification.

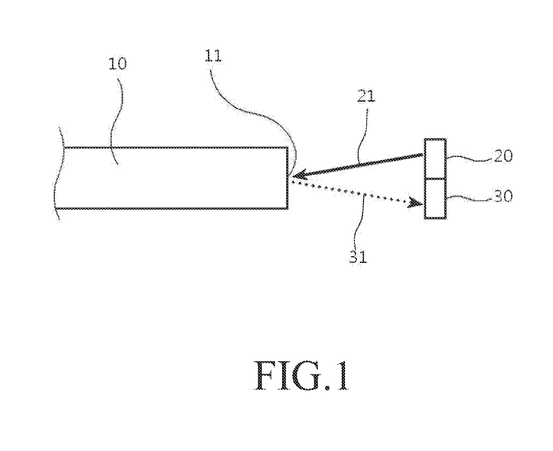

FIG. 1 is a view for explaining stimulated Brillouin scattering according to an embodiment of the present disclosure.

An optical signal 21 output from a light source 20 is coupled to an interior of an optical fiber 10 through one end 11 of an optical fiber 10. The optical fiber 10 may include a core having a relatively high refractive index and a cladding having a relatively low refractive index.

The optical fiber 10 guides the optical signal coupled to the interior thereof. The coupled optical fiber proceeds from the one end 11 of the optical fiber 10 to an opposite end thereof. The optical signal proceeds into the core through total internal reflection at a border of the core and the cladding.

Light 31 (that is, a part of the optical signal) of the optical signal that scatters in the interior of the optical fiber by Stimulated Brillouin Scattering (SBS) proceeds in a reverse direction to the optical signal and is output through the one end 11 of the optical fiber 10.

The optical signal 21 is communication light modulated to data, and the scattering light 31 corresponds to noise. The optical signal may be referred to as an optical mode, and the scattering light may be referred to as an acoustic mode.

An optical detector 30 detects the scattering light 31 as an electrical signal, and a power of the scattering light may be recognized from a power of the detected electrical signal. When an image sensor including a plurality of pixels that is used in a standard camera, is used as the optical detector, a power distribution of scattering light in the optical fiber 10 may be known. Likewise, if an optical signal output from the opposite end of the optical fiber 10 is detected by using another image sensor, a power distribution of the optical signal in the optical fiber 10 may be determined.

Scattering light that proceeds in a reverse direction to an optical signal is generated by a Brillouin scattering phenomenon that is one of a nonlinear phenomenon generated in an optical fiber, and when a power of the optical signal is greater than or equal to a threshold value, the Brillouin scattering generates a stimulating operation. Unlike another nonlinear effect, a stimulated Brillouin scattering phenomenon is generated even by a relatively lower power of an optical signal and adversely influences the quality of the optical signal.

A threshold power SBS_{threshold} of an optical signal that is a generation condition of stimulated Brillouin scattering may be expressed as in Equation 1.

$${SBS}_{threshold} [ dBm ] = \frac{21 {KA}^{ao}}{{g}_{B} {L}_{eff}} \qquad Equation 1$$

In Equation 1, K is a constant related to polarization, A^{ao} is an acousto-optic effective area, g_{B} is a peak Brillouin gain, and L_{eff} is an effective length of an optical fiber.

As may be seen in Equation 1, in order to increase a threshold power for stimulated Brillouin scattering, a value of A^{ao} may be increased by changing a refractive index profile (or graph) of an optical fiber.

A value of A^{ao} is expressed as in Equation 2.

$${A}^{ao} = {[ \frac{〈 {E}^{2} ( r ) 〉}{〈 u ( r ) {E}^{2} ( r )} ]}^{2} 〈 {u}^{2} ( r ) 〉 \qquad Equation 2$$

In Equation 2, E(r) is strength of an electric field of an optical signal according to a radial location r of an optical fiber and u(r) is strength of an electric field of scattering light according to a radial location r of an optical fiber. Then, the radial location r is measured from the center (that is, r=0) of the optical fiber.

E(r) (hereinafter, E) may be calculated through Equation 3.

∇×(∇×E)−n²k₀²E=0 Equation 3

In Equation 3, n or n(r) refers to a refractive index of an optical fiber according to a radial location r of an optical fiber and k₀ is the wave number (that is, 2π/λ) of a wavelength.

A refractive index control material increases or decreases refractive index, and for example, Ge and P increase refractive index and B and F decrease refractive index.

As in Equation 4, a refractive index n is changed according to an amount of doping of Ge. For example, Ge corresponds to a sole refractive control material of the core. The cladding may be formed of pure silica or silica doped with F that is a refractive decreasing material.

Δn=n₀(1+1e⁻³ wt(%)) Equation 4

In Equation 4, Δn is a change in refractive index according to silica doped with Ge, n₀ is a refractive index of silica, and wt(%) is an amount of doping of Ge.

u(r) (hereinafter, u) may be calculated through Equation 5.

$${Δ}_{t}^{2} u + ( \frac{{Ω}^{2}}{{V}^{2}} - {β}_{acoustic}^{2} ) u = 0 \qquad Equation 5$$

In Equation 5, V is an acoustic velocity value of a material forming an optical fiber, Ω is a Brillouin frequency transition value, β_{acoustic} is an acoustic propagation constant. Scattering light passing through an optical fiber is determined according to V or V(r).

A value of V is changed according to an amount of doping of Ge, and V may be expressed as in Equation 6.

V=5944(1−7.2e⁻³ wt(%)) Equation 6

A^{ao} may be expressed as in Equation 7.

$${A}^{ao} = \frac{{A}^{eff}}{{I}^{ao}} \qquad Equation 7$$

In Equation 7, A^{eff} refers to an effective area in an optical fiber where an optical signal is distributed and may be expressed as in Equation 8.

$${A}^{eff} = \frac{{〈 {E}^{2} 〉}^{2}}{〈 {E}^{4} 〉} \qquad Equation 8$$

Stimulated Brillouin scattering proportional to a power of an optical signal may be reduced by increasing an effective area and reducing a power per unit area of the optical signal. If a value of convolution integral expressed by I^{ao} is reduced, a threshold power for stimulated Brillouin scattering may increase.

The convolution integral of Equation 7 is a value representing a degree by which an optical signal and scattering light overlaps each other on a cross-section of an optical fiber. In order to reduce the convolution integral value, two methods may be used.

According to various embodiments of the present disclosure, a method of strongly limiting scattering light to the center of a core and a method of isolating an optical signal and scattering light by concentrating scattering light to a peripheral portion of a core are provided to reduce a convolution integral value.

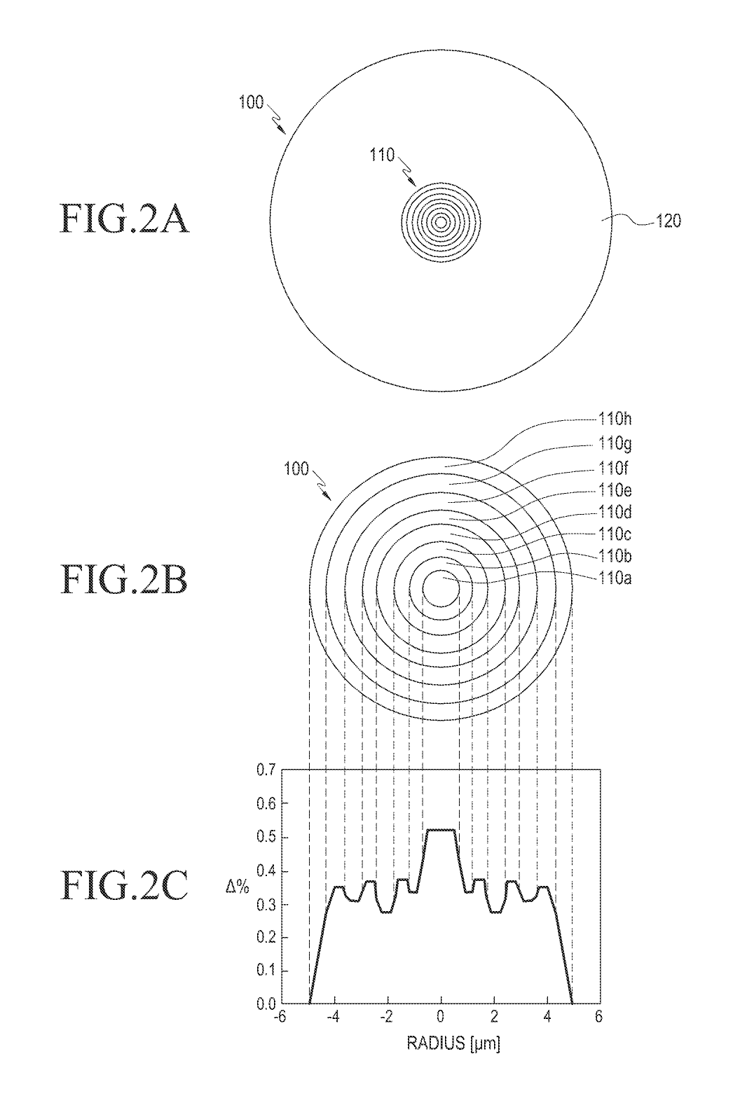

FIGS. 2A to 2C show an optical fiber according to an embodiment of the present disclosure.

Referring to FIG. 2A, a cross-section of an optical fiber 100 may include a core 110 and a cladding 120.

Referring to FIG. 2B, a cross-section of the core 110 may be divided into a plurality of sub-core areas 110a to 110h according to a difference in a refractive index. The core 110 is located at a central portion of the optical fiber 100, and has a refractive index higher than that of the cladding located at a peripheral portion of the optical fiber 100. For example, Ge corresponds to a sole refractive index control material of the optical fiber 100, the cladding 120 is formed of silica, and the core 110 is formed of a material in which silica is doped with Ge.

In this example, the core 110 is divided into eight areas, that is, first to eight sub-core areas 110a to 110h sequentially disposed circumferentially from the center of the optical fiber 100 and the first to eight sub-core areas 110a to 110h have different refractive indexes.

Referring to FIG. 2C, a refractive index profile of a core is illustrated. The horizontal axis represents a location according to a radius of the optical fiber 100 and the longitudinal axis represents a refractive index difference Δ% [the unit is %] defined by Equation 9.

$$Δ \% = \frac{n ( r ) - {n}_{0}}{{n}_{0}} \times 100 \qquad Equation 9$$

In Equation 9, n(r) is a refractive index according to a radial location r, and n₀ is a refractive index of silica. The refractive index difference Δ% refers to a percentage of a value obtained by dividing a difference between a refractive index of a corresponding sub-core area and a refractive index of a cladding by the refractive index of the cladding.

The optical fiber 100 is a single mode optical fiber satisfying a value of ITU-T G.652 that is an international standard. When it is assumed that amounts of doping of Ge of the first to eighth sub-core areas 110a to 110h are X1[110a], X1[110b], X1[110c], X1[110d], X1[110e], X1[110f], X1[110g], and X1[110h] and an amount of doping of Ge of the cladding is X1[120], the amounts of doping of Ge satisfy at least one or all of the following conditions.

X1[110a]>X1[110b], X1[110b]<X1[110c], X1[110c]>X1[110d], X1[110d]<X1[110e], X1[110e]>X1[110f], X1[110f]<X1[110g], X1[110g]>X1[110h], and X1[110h]>X1[120]

When it is assumed that refractive indexes of the first to eight sub-core areas 110a to 110h are N1[110a], N1[110b], N1[110c], N1[110d], N1[110e], N1[110f], N1[110g], and N1[110h] and a refractive index of the cladding 120 is N1[120], the refractive indexes satisfy at least one or all of the following conditions, considering that refractive index becomes high as an amount of doping of Ge becomes larger.

N1[110a]>N1[110b], N1[110b]<N1[110c], N1[110c]>N1[110d], N1[110d]<N1[110e], N1[110e]>N1[110f], N1[110f]<N1[110g], N1[110g]>N1[110h], and N1[110h]>N1[120]

Then, an amount of doping of Ge of a sub-core area may be determined as an average value, and a refractive index of the sub-core area may be determined as an average value. Alternatively, a refractive index of a sub-core area which is a maximum sub-core area having a refractive index higher than those of adjacent sub-core areas may be determined as a maximum refractive index within the sub-core area, and a refractive index of a sub-core area which is a minimum sub-core area having a refractive index lower than those of adjacent sub-core areas may be determined as a minimum refractive index within the sub-core area.

The core 110 may have a diameter of 3.2 μm to 12.8 μm. An overall diameter of the core 110 may be in a range of 6 μm to 10 μm to guide an optical signal having a wavelength of 1550 nm in a single mode. Each sub-core area may have a radial thickness of 0.2 μm to 0.8 μm.

An effective cross-section of the optical fiber 100 may be greater than or equal to 50 μm². A convolution integral value of the optical fiber 100 may be less than or equal to 0.8. A Brillouin frequency transition value of the optical fiber 100 may be greater than or equal to 9 GHz.

Each of the first to eighth sub-core areas 110a to 110h may have a refractive index difference of 0.2% to 1%. Among the first to eighth sub-core areas 110a to 110h, the first sub-core area located at the center of the optical fiber has a maximum refractive index in the optical fiber.

Among the first to eighth sub-core areas 110a to 110h, a difference between refractive indexes of two adjacent sub-core areas may be 0.02% to 0.4%.

Each of the first to seventh sub-core areas 110a to 110g may have a refractive index difference of at least 0.2%. The first sub-core area 110a may have a refractive index difference of 0.4% or 0.5%.

Since a refractive index of the eight sub-core area 110h gradually decreases as refractive index goes from an inner periphery to an outer periphery thereof in this example, the refractive index of the eight sub-core area 110h may correspond to an average refractive index thereof and refractive indexes of the remaining sub-core areas 110a to 110g may correspond to average refractive indexes or maximum/minimum refractive indexes. Unlike the example, a refractive index of the eighth sub-core area 110h may be constantly maintained at the center thereof, in which case the refractive index of the eight sub-core area 110h may correspond to an average refractive index or a minimum refractive index thereof.

The core 100 has a structure in which maximum sub-core areas having a refractive index higher than those of circumferentially adjacent sub-core areas and minimum sub-core areas having a refractive index lower than those of adjacent sub-core areas are alternately repeated, and the optical fiber 100 may have four to eight sub-core areas having the structure.

The optical fiber 100 may have at least one or all of the characteristics of a Mode Field Diameter (MFD) in a range of 8.6 μm to 9.5 μm or 8 μm to 10 μm at a wavelength of 1310 nm, a cable cutoff value of less than or equal to 1260 nm, a zero dispersion wavelength in a range of 1300 nm to 1324 nm, a dispersion inclination of 0.092 ps/(nm²·km), a dispersion value of 18 ps/(nm·km) at a wavelength of 1550 nm, a bending loss of less than or equal to 4 dB/m at a wavelength of 1625 nm with reference to a bending radius of 32 mm and 100 times of bending, and a loss of less than or equal to 0.25 dB/km at a wavelength of 1550 nm.

The optical fiber 100 may have a threshold power for stimulated Brillouin scattering of at least 10 dBm, and an increase of a threshold power for stimulated Brillouin scattering of at least 3 dB may be expected as compared with an existing step-index optical fiber.

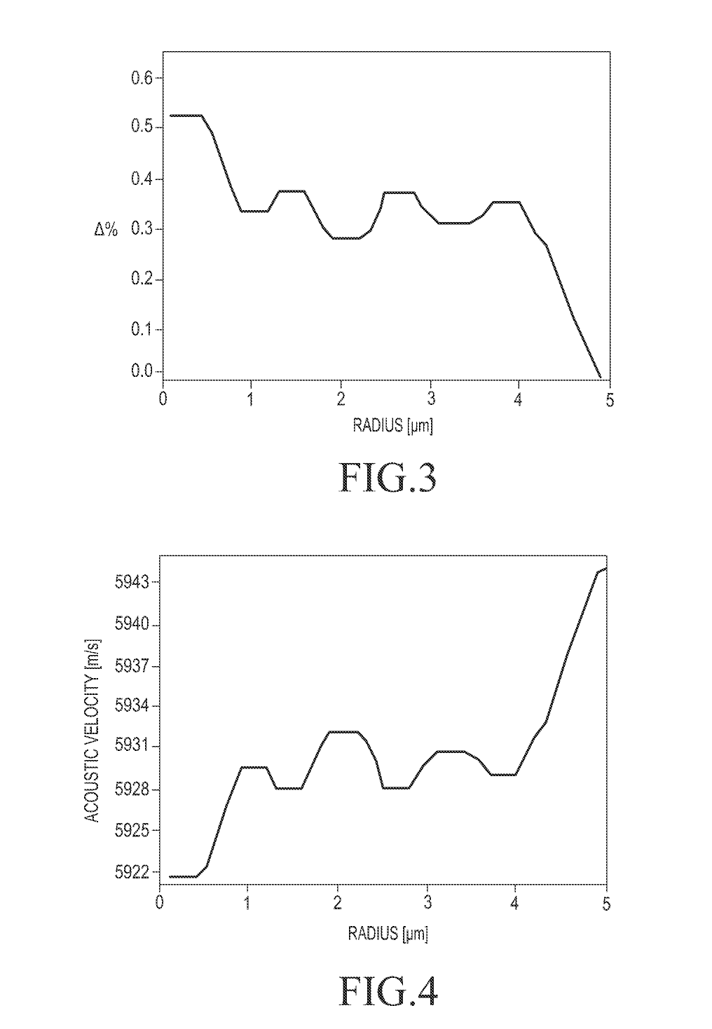

FIG. 3 shows a refractive index profile of the core 110 according to an embodiment of the present disclosure.

Referring to FIG. 3, the horizontal axis represents a location according to a radius of the optical fiber 100 and the longitudinal axis represents a refractive index difference Δ%.

FIG. 4 shows an acoustic velocity profile of the core 110 according to an embodiment of the present disclosure.

Referring to FIG. 4, the horizontal axis represents a location according to a radius of the optical fiber 100 and the longitudinal axis represents an acoustic velocity value.

Referring to FIGS. 3 and 4, it may be seen that the acoustic velocity profile has a form similar to a refractive index profile which is vertically reversed with respect to the horizontal axis.

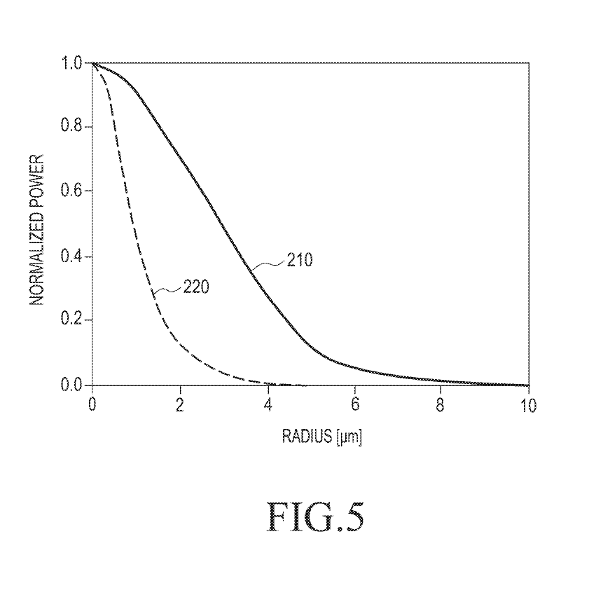

FIG. 5 shows a normalized power profile of an optical signal and a normalized power profile of scattering light according to an embodiment of the present disclosure.

Referring to FIG. 5, the horizontal axis represents a location according to a radius of the optical fiber 100 and the longitudinal axis represents a normalized power value. Then, normalization refers to adjusting a maximum value of the actual power to a preset value (1 in this example). In this example, an overlapping area of the profile 210 of the optical signal and the profile 220 of the scattering light corresponds to an area surrounded by the horizontal axis, the longitudinal axis, and the profile 220 of the scattering light. The power of the scattering light is strongly limited to the first sub-core area 110a and overlapping of the profile 210 of the optical signal and the profile 220 of the scattering light is minimized.

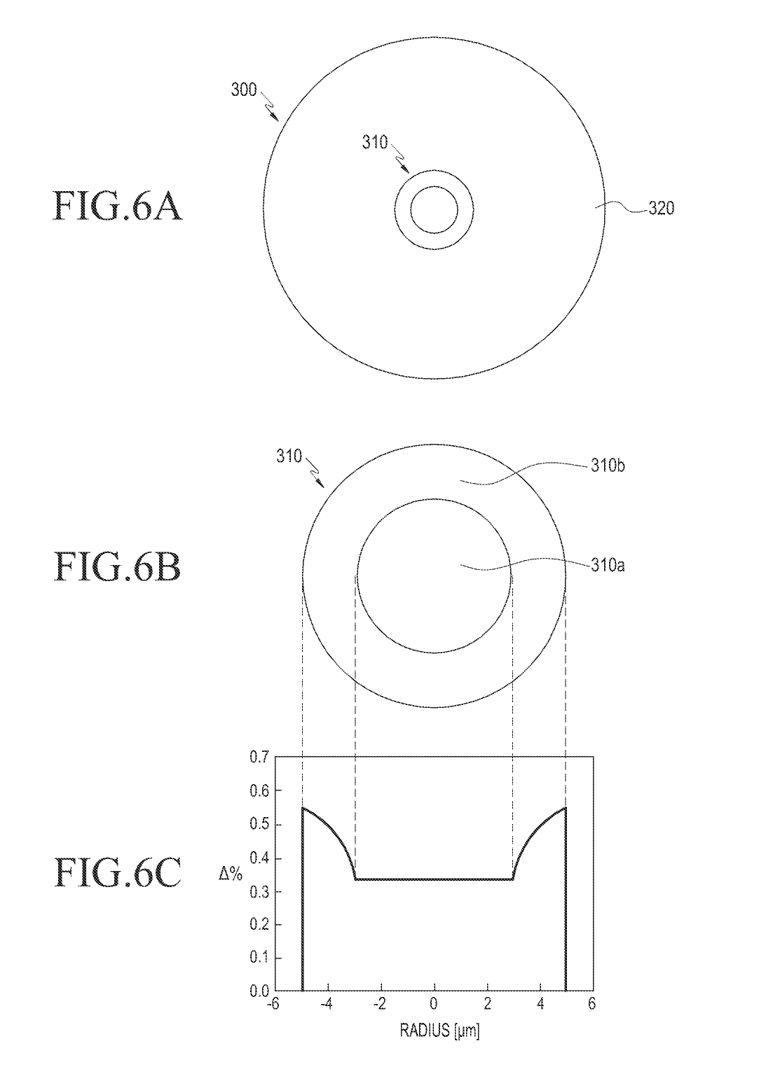

FIGS. 6A to 6C show an optical fiber according to another embodiment of the present disclosure.

Referring to FIG. 6A, the optical fiber 300 may include a core 310 and a cladding 320.

Referring to FIG. 6B, a refractive index profile of the core 310 may be divided into a plurality of sub-core areas 310a to 310b according to a difference in the refractive index. The core 310 is located at a central portion of the optical fiber 300, and has a refractive index higher than that of the cladding 320 located at a peripheral portion of the optical fiber 300. For example, Ge corresponds to a sole refractive index control material of the optical fiber 300, the cladding 320 is formed of silica, and the core 310 is formed of a material in which silica is doped with Ge.

In this example, the core 310 is divided into two areas, that is, first and second sub-core areas 310a to 310b sequentially disposed circumferentially from the center of the optical fiber 300 and the first and second sub-core areas 310a and 310b have different refractive indexes.

Referring to FIG. 6C, the horizontal axis represents a location according to a radius of the optical fiber 300 and the longitudinal axis represents a refractive index difference Δ% defined by Equation 9.

The optical fiber 300 is a single mode optical fiber satisfying a value of ITU-T G.652 that is an international standard. When it is assumed that amounts of doping of Ge of the first and second sub-core areas 310a are X2[310a] and X2[310b], and an amount of doping of Ge of the cladding is X2[320], the amounts of doping of Ge satisfy at least one or all of the following conditions.

X2[310a]<X2[310b] and X2[310b]>X2[320]

When it is assumed that refractive indexes of the first and second sub-core areas 310a and 310b are N1[310a] and N1[310b] and a refractive index of the cladding 320 is N2[320], the refractive indexes satisfy at least one or all of the following conditions, considering that the refractive index becomes high as an amount of doping of Ge becomes larger.

N2[310a]<N2[310b] and N2[310b]>N2[320]

Then, an amount of doping of GE of a sub-core area may be determined as an average value, and a refractive index of the sub-core area may be determined as an average value. Alternatively, a refractive index of the first sub-core area 310a which is a minimum sub-core area having a refractive index lower than that of the adjacent second sub-core area 310b may be determined as a minimum refractive index within the first sub-core area 310a, and a refractive index of the second sub-core area 310b which is a maximum sub-core area having a refractive index higher than that of the adjacent first sub-core area 310a may be determined as a maximum refractive index within the second sub-core area 310b.

In this example, the first sub-core area 310a has a constant refractive index and the second sub-core area 310b has a refractive index which gradually increases as refractive index goes from an inner periphery to an outer periphery thereof.

The core 310 may has a diameter in a range of 4.4 μm to 12.0 μm. An overall diameter of the core 310 may be in a range of 6 μm to 10 μm to guide an optical signal having a wavelength of 1550 nm in a single mode. The first sub-core area 310a may have a radial thickness of less than or equal to 3 μm and the second sub-core area 310b may have a radial thickness of greater than or equal to 1.2 μm or 2.4 μm.

An effective cross-section of the optical fiber 300 may be at least 50 μm². A convolution integral value of the optical fiber 300 may be less than or equal to 0.8. A Brillouin frequency transition value of the optical fiber 300 may be at least 9 GHz.

The first sub-core area 310a may have a refractive index difference of 0.2% to 0.4%. The second sub-core area 310b may have a refractive index difference of 0.4% to 0.7%.

An average inclination of the second sub-core area 310b may be 0.07%/μm to 0.41%/μm.

The optical fiber 300 may have at least one or all of the characteristics of a Mode Field Diameter (MFD) in a range of 8.6 μm to 9.5 μm or 8 μm to 10 μm at a wavelength of 1310 nm, a cable cutoff value of less than or equal to 1260 nm, a zero dispersion wavelength in a range of 1300 nm to 1324 nm, a dispersion inclination of 0.092 ps/(nm²·km), a dispersion value of 18 ps/(nm·km) at a wavelength of 1550 nm, a bending loss of less than or equal to 4 dB/m at a wavelength of 1625 nm with reference to a bending radius of 32 mm and 100 times of bending, and a loss of less than or equal to 0.25 dB/km at a wavelength of 1550 nm.

The optical fiber 300 may have a threshold power for stimulated Brillouin scattering of at least 10 dBm, and an increase of a threshold power for stimulated Brillouin scattering of at least 3 dB may be expected as compared with an existing step-index optical fiber.

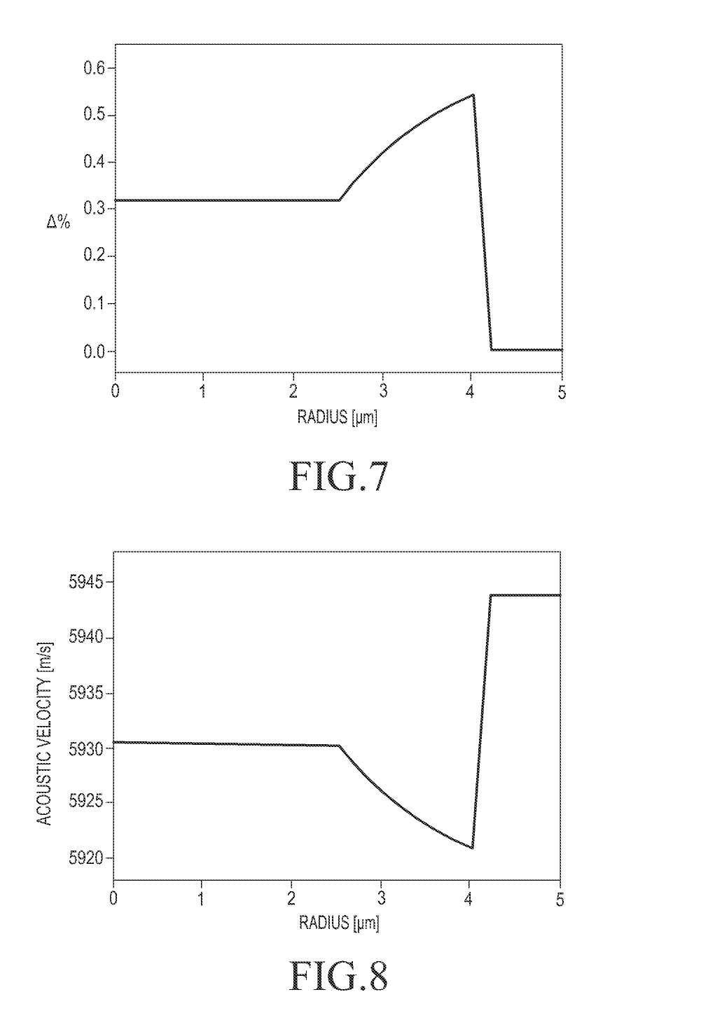

FIG. 7 shows a refractive index profile of the core 310 according to an embodiment of the present disclosure.

Referring to FIG. 7, the horizontal axis represents a location according to a radius of the optical fiber 300 and the longitudinal axis represents a refractive index difference Δ%.

FIG. 8 shows an acoustic velocity profile of the core 310 according to an embodiment of the present disclosure.

Referring to FIG. 8, the horizontal axis represents a location according to a radius of the optical fiber 300 and the longitudinal axis represents an acoustic velocity value.

Referring to FIGS. 7 and 8, it may be seen that the acoustic velocity profile has a form similar to a refractive index profile which is vertically reversed with respect to the horizontal axis.

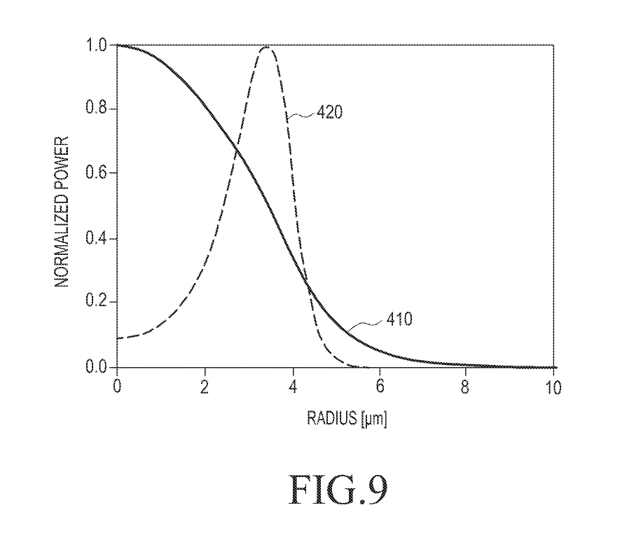

FIG. 9 shows a normalized power profile of an optical signal and a normalized power profile of scattering light according to an embodiment of the present disclosure.

Referring to FIG. 9, the horizontal axis represents a location according to a radius of the optical fiber 300 and the longitudinal axis represents a normalized power value. Then, normalization refers to adjusting a maximum value of the actual power to a preset value (1 in this example). The profile 420 of the scattering light is strongly limited to the second sub-core area and overlapping of the profile 410 of the optical signal and the profile 420 of the scattering light is minimized.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An optical fiber comprising:
a core located at the center of the optical fiber and having a maximum refractive index in the optical fiber; and
a cladding located at a circumference of the core and having a refractive index lower than that of the core,
wherein the core has a structure in which sub-core areas having the refractive index higher than those of adjacent sub-core areas and sub-core areas having the refractive index lower than those of adjacent sub-core areas are alternately repeated.

2. The optical fiber of claim 1, wherein the core comprises first to fourth sub-core areas radially sequentially disposed and having refractive indexes of N1[a], N1[b], N1[c], and N1[d], respectively and the cladding has a refractive index of N1[i], and a relationship of N1[a]>N1[b], N1[b]<N1[c], N1[c]>N1[d], and N1[d]>N1[i] is satisfied.

3. The optical fiber of claim 1, wherein the core comprises first to eight sub-core areas radially sequentially disposed and having refractive indexes of N1[a], N1[b], N1[c], N1[d], N1[e], N1[f], N1[g], and N1[h], respectively and the cladding has a refractive index of N1[i], and a relationship of N1[a]>N1[b], N1[b]<N1[c], N1[c]>N1[d], N1[d]<N1[e], N1[e]>N1[f], N1[f]<N1[g], N1[g]>N1[h], and N1[h]>N1[i] is satisfied.

4. The optical fiber of claim 1, wherein the core is formed of a material in which silica is doped only with Ge.

5. The optical fiber of claim 1, wherein the core has a diameter in a range of 3.2 μm to 12.8 μm and each sub-core area has a radial thickness in a rage of 0.2 μm to 0.8 μm.

6. The optical fiber of claim 1, wherein an effective cross-section of the optical fiber is great than or equal to 50 μm², a convolution integral value of the optical fiber is less than or equal to 0.8, and a Brillouin frequency transition value of the optical fiber is at least 9 GHz.

7. The optical fiber of claim 1, wherein each of the sub-core areas have a refractive index difference in a range of 0.2% to 1% and a sub-core area located at the center of the optical fiber has the maximum refractive index in the optical fiber.

8. The optical fiber of claim 1, wherein a difference between refractive indexes of adjacent two sub-core areas of the sub-core areas is in a range of 0.02% to 0.4%.

9. The optical fiber of claim 1, wherein the optical fiber has at least one of a mode field diameter in a range of one of 8.6 μm to 9.5 μm and 8 μm to 10 μm at a wavelength of 1310 nm, a zero dispersion wavelength in a range of 1300 nm to 1324 nm, a dispersion inclination of 0.092 ps/(nm²·km), a dispersion value of 18 ps/(nm·km) at a wavelength of 1550 nm, a bending loss of less than or equal to 4 dB/m at a wavelength of 1625 nm with reference to a bending radius of 32 mm and 100 times of bending, and a loss of less than or equal to 0.25 dB/km at a wavelength of 1550 nm.

10. The optical fiber of claim 1, wherein the optical fiber has a threshold power for stimulated Brillouin scattering of at least 10 dBm.

11. An optical fiber comprising:
a core located at the center of the optical fiber and having a maximum refractive index in the optical fiber; and
a cladding located at a circumference of the core and having a refractive index lower than that of the core,
wherein the core has a first sub-core area located at the center of the core and a second sub-core area located at a circumference of the first sub-core area and having a refractive index which gradually increases as the refractive index goes toward an outer periphery thereof.

12. The optical fiber of claim 11, wherein the first and second sub-core areas are radially sequentially disposed and have refractive indexes of N2[a] and N2[b], respectively and the cladding has a refractive index of N1[c], and a relationship of N2[a]<N2[b] and N2[b]>N2[c] is satisfied.

13. The optical fiber of claim 11, wherein the first sub-core area has a constant refractive index.

14. The optical fiber of claim 11, wherein the core is formed of a material in which silica is doped only with Ge.

15. The optical fiber of claim 11, wherein the core has a diameter in a range of 4.4 μm to 12.0 μm, the first sub-core area has a radial thickness of less than or equal to 3 μm, and the second sub-core area has a radial thickness of greater than or equal to 1.2 μm.

16. The optical fiber of claim 11, wherein an effective cross-section of the optical fiber is greater than or equal to 50 μm², a convolution integral value of the optical fiber is less than or equal to 0.8, and a Brillouin frequency transition value of the optical fiber is at least 9 GHz.

17. The optical fiber of claim 11, wherein the first sub-core area has a refractive index difference of 0.2% to 0.4% and the second sub-core area has a refractive index difference of 0.4% to 0.7%.

18. The optical fiber of claim 11, wherein an average inclination of a refractive index of the second sub-core area ranges from 0.07%/μm to 0.41%/μm.

19. The optical fiber of claim 1, wherein the optical fiber has at least one of a mode field diameter in a range of one of 8.6 μm to 9.5 μm and 8 μm to 10 μm at a wavelength of 1310 nm, a zero dispersion wavelength in a range of 1300 nm to 1324 nm, a dispersion inclination of 0.092 ps/(nm²·km), a dispersion value of 18 ps/(nm·km) at a wavelength of 1550 nm, a bending loss of less than or equal to 4 dB/m at a wavelength of 1625 nm with reference to a bending radius of 32 mm and 100 times of bending, and a loss of less than or equal to 0.25 dB/km at a wavelength of 1550 nm.

20. The optical fiber of claim 11, wherein the optical fiber has a threshold power for stimulated Brillouin scattering of at least 10 dBm.
